(19) United States
(12) Patent Application Publication
(10) Pub. No.: US 2006/0036512 A1
(43) Pub. Date: Feb. 16, 2006

(54) System and method for interpreting sales data through the use of natural language questions

(75) Inventors: John D. Maccarthy, Bucks (GB); Christopher D. Fournier, Toronto (CA); Amanda Culley, Middx (GB); David Kenneth Twinberrow, Hertfordshire (GB)

Correspondence Address: BAKER & BOTTS, 30 ROCKEFELLER PLAZA, NEW YORK, NY, 10112, US

(73) Assignee: IMS SOFTWARE SERVICES, LTD., Plymouth, PA (US)

(21) Appl. No.: 10/494,785

(22) PCT Filed: Oct. 1, 2002
(86) PCT No.: PCT/US02/31204

§ 371 Date: Feb. 11, 2005

(51) Int. Cl. G06F 17/30

(52) U.S. Cl. 705/27

(57) ABSTRACT

A sales management data analysis system and method for interpreting raw sales management data are provided. A plurality of natural language questions are provided, wherein each of the natural language questions correspond to at least one database query. An at least one database is queried in accordance with a selected one of the plurality of natural language questions. A particular data set is created responsive to the querying of the at least one database in accordance with the one of the plurality of natural language questions from the at least one database. And the particular data set is sent to a destination, the particular data set configured to be able to provide a particular visual interpretation thereof, wherein the particular visual interpretation is of a particular type.

### BACKGROUND OF THE INVENTION

1. Field of the Invention

The present invention relates to techniques for interpreting sales information and more particularly, to such techniques which employ natural language questions.

2. Description of Related Art

Manufacturers and distributors of retail products generally monitor product sales in order to maintain proper inventory and to be able to direct marketing efforts. Monitoring may be accomplished by documenting sales at retail outlets and transferring this sales data to a central point for evaluation. Sales data are valuable as a business intelligence tool to regularly inform sales professionals about the state of the marketplace.

Each day throughout the pharmaceutical and healthcare industries millions of products are sold worldwide. Prescriptions are written by doctors and filled at pharmacies; medical devices are sold at doctors offices, hospitals and pharmacies. Individual businesses participating in various aspects of the pharmaceutical and healthcare industries create data pertaining to the goods sold to conform with governmental regulations and to aid in inventory tracking.

Utilizing highly advanced technologies, this raw, disparate data is transformed from millions of pharmaceutical records collected from thousands of sources worldwide into a centralized data repository. The information contained in the centralized data repository is a powerful business intelligence tool that can be used to gain critical information about the state of the industry.

However, extracting crucial information from the raw information contained in the centralized data repository and forming a coherent understanding of the impact of the raw information is difficult for individual sales personnel to accomplish.

### SUMMARY OF THE INVASION

Accordingly, there exists a need for a business intelligence tool, which allows a user or users to access available raw sales management data in a meaningful and time efficient manner.

An object of the present invention is to provide a method of analyzing sales management data. The method of analyzing sales management data includes the steps of: providing a plurality of natural language questions relating to said sales management data, wherein each of the natural language questions corresponds to at least one database query, receiving an indication of a selected one or more of the natural language questions from the plurality of natural language questions, querying at least one database in accordance with the selected one or more of the natural language questions, and creating a particular data set responsive to the querying step, wherein the particular data set is configured to be able to provide a particular visual interpretation thereof, wherein the particular visual interpretation is of a particular type.

Another object of the present invention is to provide a method of analyzing sales management data. The method of analyzing sales management data including the steps of: providing a plurality of natural language questions, wherein each of the natural language questions correspond to at least one database query, selecting one or more of the natural language questions from the plurality of natural language questions, issuing an at least one query to at least one database in accordance with the selected one or more of the plurality of natural language questions, receiving a particular data set responsive to the issuing step, and analyzing the particular data set and providing a particular visual interpretation thereof, wherein the particular visual interpretation is of a particular type.

Still another object of the present invention is to provide a sales management data analysis system. The sales management data analysis system including a data storage unit including a mass storage device, the data storage unit including at least one database, a processor operatively connected to the data storage unit and configured to provide a plurality of natural language questions, wherein each of the natural language questions correspond to at least one database query, to query the at least one database in accordance with a selected one of the plurality of natural language questions, to create a particular data set responsive to the querying of the at least one database in accordance with the one of the plurality of natural language questions from the at least one database, and a communication interface, operatively connected to the processor configured to send the particular data set to a destination, the particular data set configured to be able to provide a particular visual interpretation thereof, wherein the particular visual interpretation is of a particular type.

### BRIEF DESCRIPTION OF THE DRAWING

Further objects, features and advantages of the invention will become apparent from the following detailed description taken in conjunction with the accompanying figures showing illustrative embodiments of the invention, in which:

FIG. 1 is a block diagram of a data analysis and presentation system according to an exemplary embodiment of the present invention;

FIG. 2 is a flow chart of the process through which a client data presentation application processes data according to an exemplary embodiment of the present invention;

FIG. 3 is a desktop block diagram of the client data presentation application according to an exemplary embodiment of the present invention;

FIG. 4 is a desktop block diagram of the client data presentation application according to an exemplary embodiment of the present invention;

FIG. 5 is a desktop block diagram of the client data presentation application according to an exemplary embodiment of the present invention;

FIG. 6 is a desktop block diagram of the client data presentation application according to an exemplary embodiment of the present invention;

FIG. 7 is a desktop block diagram of the client data presentation application according to an exemplary embodiment of the present invention;

FIG. 8 is a desktop block diagram of the client data presentation application according to an exemplary embodiment of the present invention;

FIG. 9 is a desktop block diagram of the client data presentation application according to an exemplary embodiment of the present invention;

FIG. 10 is a desktop block diagram of the client data presentation application according to an exemplary embodiment of the present invention;

FIG. 11 is a desktop block diagram of the client data presentation application according to an exemplary embodiment of the present invention; and

FIG. 12 is a desktop block diagram of the client data presentation application according to an exemplary embodiment of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE INVENTION

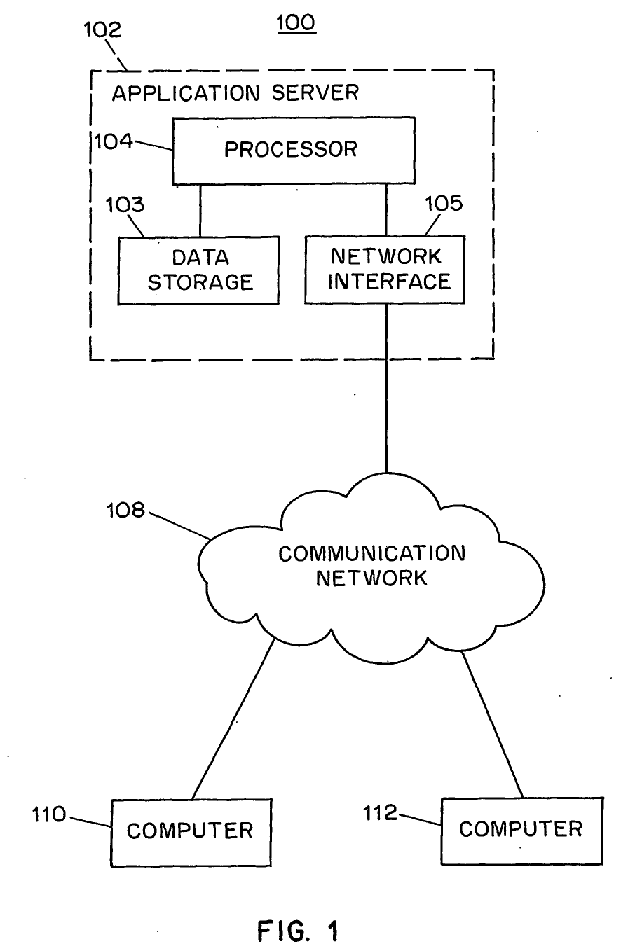

FIG. 1 illustrates a database analysis system 100 according to an exemplary embodiment of the present invention. The database analysis system 100 includes an application server 102, a communications network 108, a client computer 110 and a client computer 112.

The application server 102 includes a processor 104, a data storage unit 103 and a network interface 105. The processor 104 runs a database application and a firewall. The firewall protects data stored in the data storage unit 103 from unauthorized access by individuals and programs (sometimes called viruses). The database application allows client data presentation applications, executing on the client computers 110, 112, to query a user database and a sales management information database through the firewall. Preferably, the database application is a Microsoft SQL server database which uses Online Analytical Processing Data Cubes for the organization of large data sources. The data storage unit 103 includes volatile and nonvolatile memory as well as mass storage devices.

The sales management information database is stored in the data storage unit 103. The sales management information database acts as a central repository for information pertaining to goods sold and prescriptions issued throughout the pharmaceutical and healthcare industry. The sales management information database is populated using information gathered from individual businesses participating in various aspects of the pharmaceutical and healthcare industries. These individual businesses create data pertaining to goods sold in order to conform with governmental regulations and to aid in inventory tracking. This information typically includes sales data, physician names and corresponding addresses, complete contact information by physician, complete contact information relating to a product for a geographical area, investment per physician, investment per product per geographical area, amount spent per physician, amount spent per product per geographical area, physician count per geographical area, physician segment, physician target status, sales targets by geographical area, sales targets by territory, quotas by geographical area, quotas by territory, sales territory information, number of prescriptions issued by a doctor, number of prescriptions issued for a particular product, the time a prescription is provided, the product prescribed, the market in which a prescription is issued, the geographic area in which the prescription was filled, the amount of prescriptions written by a group of doctors, the amount of prescriptions dispensed by a group of doctors, and the like. Preferably, the information is then standardized, filtered to insure an acceptable quality level, and written into the sales management information database in the data storage unit 103.

The data storage unit 103 also includes a user database. The user database includes database records specifying user accounts. Associated with each user's account, and provided in the user's account record in the user database, is a username, password, default question, default query, default visual interpretation type, territory information, and sales campaign question information. The sales campaign question information includes a list of questions and associated parameters, each question of the list of questions is associated with a group of parameters.

In a preferred embodiment, the list of questions specified in a user's account are developed on a case by case basis. The questions are usually sales territory type questions or specialty type questions. Some examples of sales territory type questions follow:

How am I doing against the competition?

Where is my potential?

How does my performance compare to the market?

How am I doing against the target?

How effective are my calls?

Some examples of specialty type questions follow:

How am I doing against the competition by specialty?

Where is my potential by specialty?

How does my performance compare to the market by specialty?

How effective are my calls by specialty?

What is the contribution of each specialty?

As used herein, natural language questions are questions that are written in language readily understandable to a user, so that a user need not have a working knowledge of a computer language, such as standard query language or a general purpose programming language, in order to understand the natural language questions.

The processor 104 receives information to be written into the data storage unit 103 from a multitude of sources through the communication network 108 and the network interface 105 and the processor 104 receives database queries from the client computers 110, 112 through the communication network 108 and the network interface 105. The network interface 105 is in communication with the communications network 108 and the processor 104. The network interface 105 receives queries from the communication network 108, which are in turn supplied to the processor 104 and supplies data, received from the data storage device 103 via the processor 104, to the communications network 108 responsive to the database queries. The network interface 105 also receives information about goods sold and prescriptions issued throughout the pharmaceutical and healthcare industry from the communication network 108. The network interface 105 is preferably an Ethernet interface.

The communications network 108 allows the application server 106 to communicate with the client computers 110, 112. Preferably, the communications network 108 is the Internet.

The client computer 110 executes the client data presentation application. The client data presentation application is a business intelligence tool, which allows a user or users to access the multitude of raw data stored on the application server 102 in a meaningful and time efficient manner. The client data presentation application does not contain any data itself. All data upon which the client data presentation application operates is stored in the sales management information database and the user database which are located on the data storage unit 103 of the application server 102. Preferably, the client computer 110 is a general purpose personal computer.

It should be understood that the client computer 112 executes the client data presentation application in a similar manner to the client computer 110. For the sake of simplicity, the function of the client data presentation application will be described in relation to the client computer 110 only, though it will be understood that the client data presentation application would act in the same manner if executed on the client computer 112.

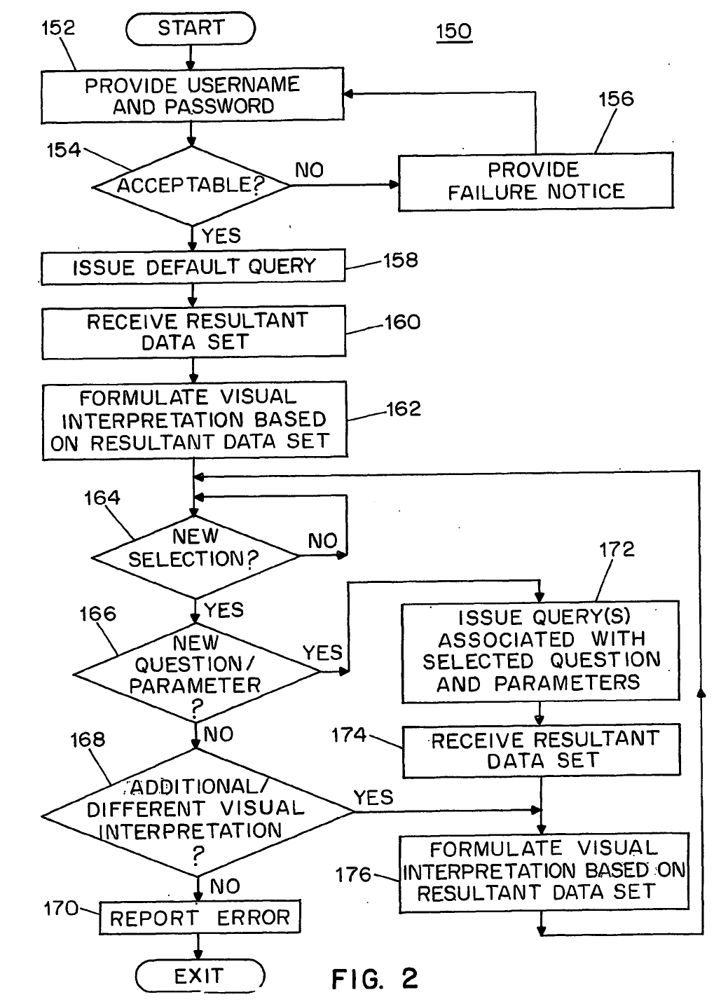

FIG. 2 illustrates a data presentation process 150 through which a user can receive information from the client data presentation application. The process 150 begins at step 152.

At step 152 the user provides a username and password to the client is data presentation application. In order to use the client data presentation application a user must login to the system. Once the user has provided a username and password, the process 150 advances to step 154.

At step 154 the process 150 issues a database query to the application server 102. The application server 102 receives this query via the network interface 105 and in turn queries the user database for a database record specifying a user account having the entered username and password combination. If such a record exists, the application server 102 returns a login valid message to the process 150 along with the default question, the default query, the default visual interpretation type, the territory information, and the sales campaign question information supplied in the user's account record. The process 150 records the received information in a local user account profile and advances to step 158. Otherwise, if no such record exists, the application server 102 returns a login invalid message to the process 150 and the process 150 advances to step 156.

At step 156, the process 150 provides the user with a login invalid message. The process 150 advances to step 152, and the user may again specify a username and password combination.

At step 158, the process 150 issues a query to the application server 102. The issued query is the default query stored in a local user account profile. The application server 102 receives the issued query via the network interface 105 and in turn queries the sales management information database for database records which satisfy the database query.

At step 160, the process 150 waits to receive the resultant data set from the application server 102. Once the application server 102 has received the resultant data set from the sales management information database in response to the initial query, the application server sends the resultant data set to the client computer 110. The client computer 110 stores the resultant data set locally within the client computer 110 for further interpretation by the client data presentation application.

At step 162, the client data presentation application formulates a visual interpretation or multiple visual interpretations based on the resultant data set stored within the client computer 110, and populates various fields of the client data presentation application including any visual interpretation boxes, a parameter specification box, a sales territory indicator, and a question drop down menu with default values. The client data presentation application analyzes the resultant data set and provides a visual interpretation thereof in a style specified by the default visual interpretation type. The default visual interpretation type can be a chart, color coded line graph, color coded map, customer list or color coded bar chart.

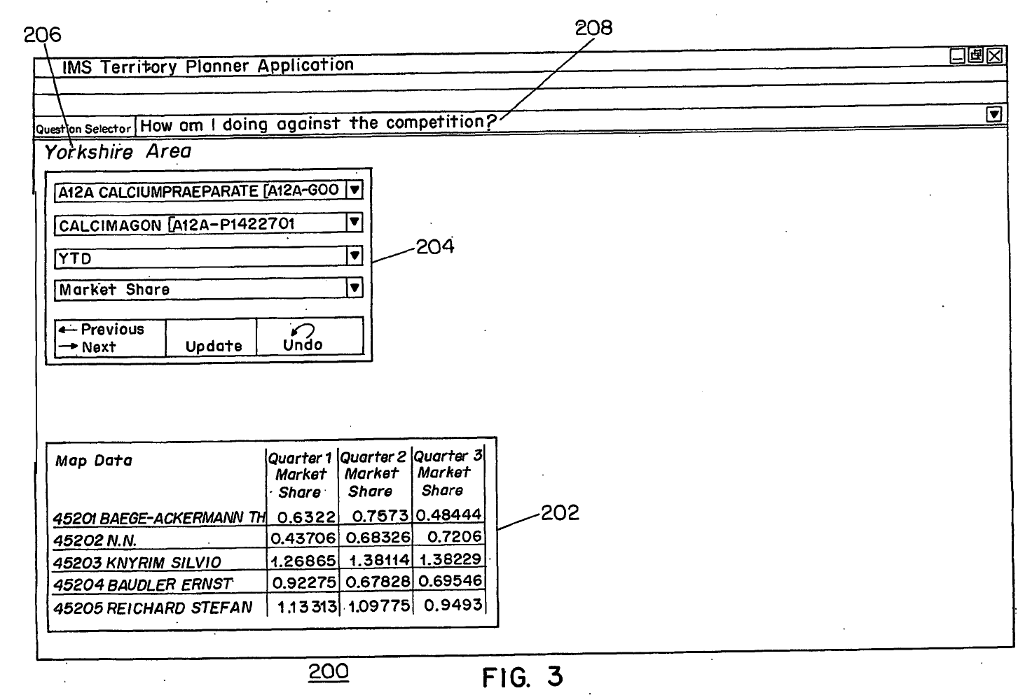

Referring now to FIG. 3, a desktop block diagram 200 of the client data presentation application is provided with exemplary default data specified. The client data presentation application includes a desktop upon which different data is presented to the user. The desktop block diagram 200 includes a visual interpretation box 202, a parameter specification box 204, a sales territory indicator 206 and a question drop down menu 208. The visual interpretation box 202 includes a interpretation type (here a chart) and a visual interpretation of the resultant data set of the type indicated by the interpretation type. The question drop down menu 208 is populated with the list of questions specified by the sales campaign question information stored in the local user account profile, such that the default question stored in the local user account profile is visible if the drop down functionality of the drop down menu 208 is not activated. If the arrow next to the question drop down menu 208 is clicked, the drop down functionality of the question drop down menu 208 is activated and the drop down menu displays the list of questions supplied with the sales campaign question information stored in the local user account profile. The parameter specification box 204 includes multiple drop down boxes, each of which contain multiple parameters associated with the selected question of the list of questions specified by the sales campaign information stored in the local user account profile. The parameters shown in the parameter specification box 204 are default values specified in the local user account profile. The sales territory indicator 206 displays the territory information contained within the local user account profile. The sales territory indicator 206 acts as a reminder to the user as to what territory the displayed information pertains.

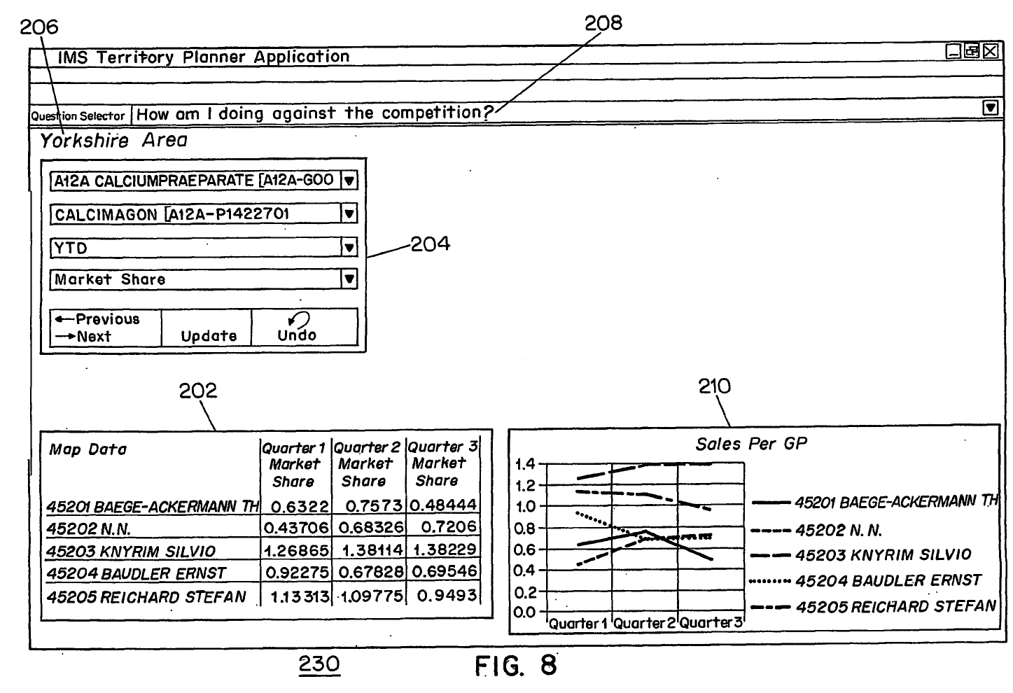

Referring again to FIG. 2, in a preferred embodiment, the default visual interpretation type can specify multiple visual interpretation types. By specifying multiple visual interpretation types, the client data presentation application will provide a user with multiple visual interpretation boxes having different interpretation types for the data, for example a user might be presented with a chart type visual interpretation and a color coded line graph type visual interpretation of the resultant data set, as shown by a desktop block diagram 230 of FIG. 8. In another preferred embodiment, the default visual interpretation type can specify multiple visual interpretation types, placements for each of the specified visual interpretation types, and sizes for each of the specified visual interpretation types.

At step 164, if the process 150 determines whether the visual interpretations need to be updated. If the user has indicated that the visual interpretations need to be updated, if the user has selected an additional visual interpretation to be displayed, or if the user has selected a different visual interpretation to be displayed, the process 150 advances to step 166. Otherwise, the process 150 remains at step 164.

At step 166, the process 150 determines whether the user indicated that the visual interpretations need to be updated. If the user selected a new question to be answered or altered a parameter of the current question and indicated that the visual interpretations need to be updated by clicking on the update button, the client data presentation application must issue a new query to the application server 102. The user may select a new question to be answered by activating the drop down functionality of the question drop down menu 208 and selecting another of the listed questions. The user may also select a new parameter to be explored using the question specified in the question drop down menu 208 by selecting a new parameter in the parameter specification box 204. Once the appropriate question and parameters have been selected, the user may click on the update button. If the user clicked on the update button, the process 150 advances to step 172. If the user has not clicked on the update button, the process 150 advances to step 168.

At step 168, the process 150 determines whether the user selected an additional visual interpretation to be displayed or selected a different visual interpretation to be displayed. If the user selected an additional visual interpretation to be displayed or if the user selected a different visual interpretation to be displayed, the client data presentation application should formulate an additional visual interpretation based on the resultant data set currently stored by the client data presentation application, therefore the process 150 advances to step 174. If the user did not select an additional visual interpretation to be displayed or select a different visual interpretation to be displayed, the process 150 advances to step 170.

At step 170, the process 150 reports an error condition. If the user did not indicate that the visual interpretations need to be updated, select an additional visual interpretation to be displayed, or select a different visual interpretation to be displayed, an error must be reported. Once the error is reported, the process 150 exits.

At step 172, the process 150 issues a query to the application server 102. The issued query is the query specified by the selection of a specific question through the question drop down menu 208 and specific parameters through the parameter specification box 204. The application server 102 receives the issued query via the network interface 105 and in turn queries the sales management information database for database records which satisfy the database query.

At step 174, the process 150 waits to receive the resultant data set from the application server 102. Once the application server 102 has received the resultant data set from the sales management information database in response to the issued query, the application server sends the resultant data set to the client computer 110. The client computer 110 stores the resultant data set locally within the client computer 110 for further interpretation by the client data presentation application.

At step 176, the client data presentation application formulates a visual interpretation or multiple visual interpretations based on the resultant data set stored within the client computer 110. The client data presentation application analyzes the resultant data set and provides a visual interpretation thereof in a type specified by the interpretation type of each of the visual interpretation boxes present on the desktop of the client data presentation application. The visual interpretation type can be a chart, color coded line graph, color coded map, customer list or color coded bar chart. Once the visual interpretations are supplied to the various visual interpretation boxes provided on the desktop of the client data presentation application, the process 150 advances to step 164.

In an alternate embodiment, the database application running on the application server 102 would run on the client computers 110, 112 and the sales management information database and the user database stored in the data storage unit 103 would be stored on the client computers 110, 112, such that the client computers 110, 112 would issue queries to the database application and databases located on the client computers 110, 112, not over the communications network 108. This would allow the client data presentation application to be reliant only upon data stored within the client computers 110, 112. No other hardware would be involved.

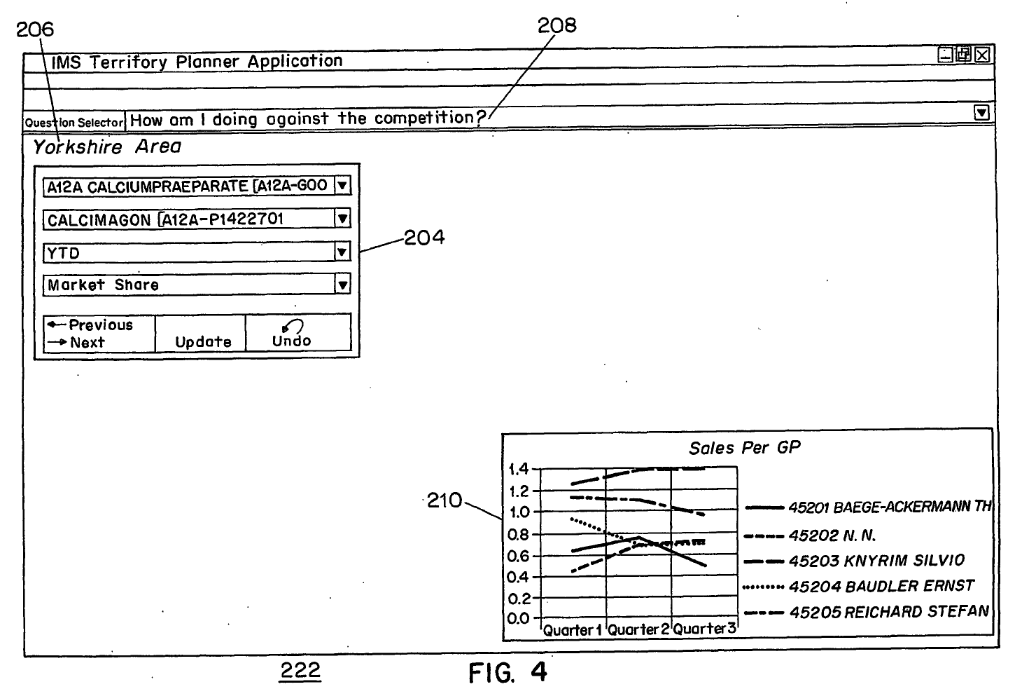

Referring now to FIG. 4, a desktop block diagram 222 of the client data presentation application is provided. The desktop block diagram 222 is largely the same as the desktop block diagram 200, except that the visual interpretation box 202 is not provided and a visual interpretation box 210 is provided. The visual interpretation box 210 includes a interpretation type (here a color coded line graph) and a visual interpretation of the resultant data set of the type indicated by the interpretation type.

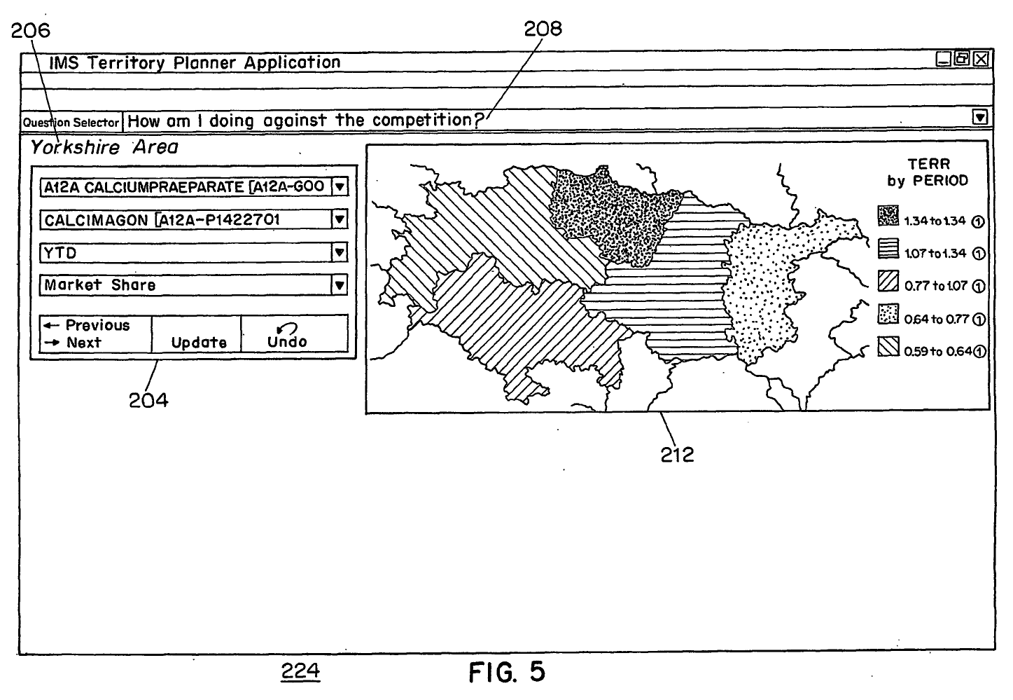

Referring now to FIG. 5, a desktop block diagram 224 of the client data presentation application is provided. The desktop block diagram 224 is largely the same as the desktop block diagram 200, except that the visual interpretation box 202 is not provided and a visual interpretation box 212 is provided. The visual interpretation box 212 includes an interpretation type (here a color coded map) and a visual interpretation of the resultant data set of the type indicated by the interpretation type.

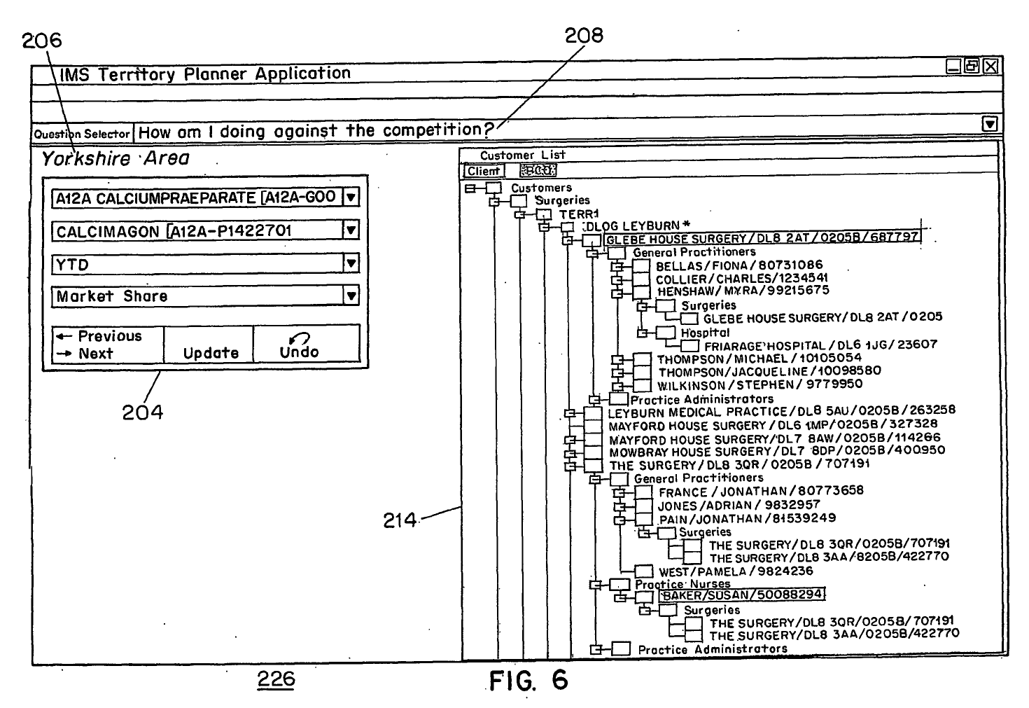

Referring now to FIG. 6, a desktop block diagram 226 of the client data presentation application is provided. The desktop block diagram 226 is largely the same as the desktop block diagram 200, except that the visual interpretation box 202 is not provided and a visual interpretation box 214 is provided. The visual interpretation box 214 includes an interpretation type (here a customer list) and a visual interpretation of the resultant data set of the type indicated by the interpretation type.

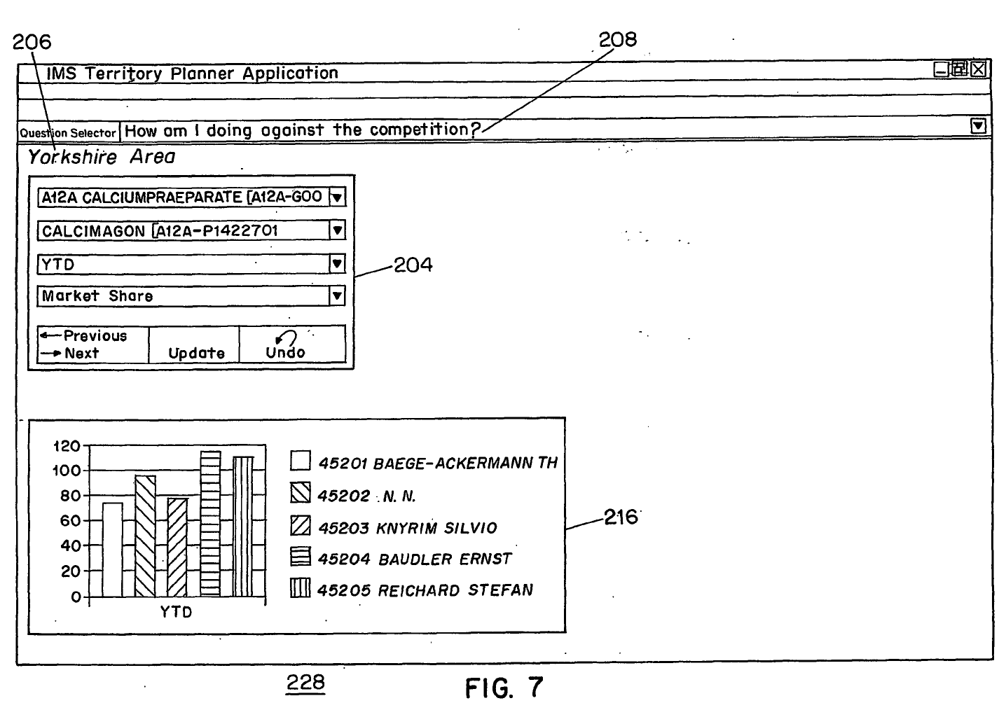

Referring now to FIG. 7, a desktop block diagram 228 of the client data presentation application is provided. The desktop block diagram 228 is largely the same as the desktop block diagram 200, except that the visual interpretation box 202 is not provided and a visual interpretation box 216 is provided. The visual interpretation box 216 includes an interpretation type (here a color coded bar graph) and a visual interpretation of the resultant data set of the type indicated by the interpretation type.

Referring now to FIG. 8, a desktop block diagram 230 of the client data presentation application is provided. The desktop block diagram 228 is largely the same as the desktop block diagram 200, except that an additional visual interpretation box, the visual interpretation box 210, is provided. The visual interpretation box 202 includes a visual interpretation of the resultant data set of the chart type and the visual interpretation box 210 includes a visual interpretation of the resultant data set of the color coded line graph type.

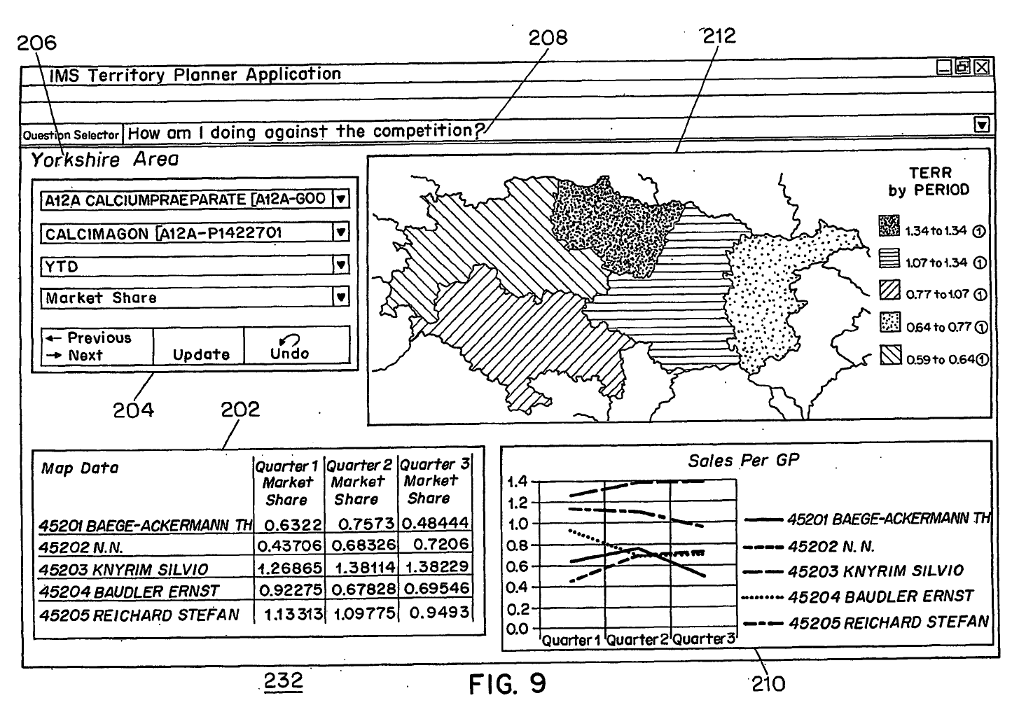

Referring now to FIG. 9, a desktop block diagram 232 of the client data presentation application is provided. The desktop block diagram 228 is largely the same as the desktop block diagram 230, except that an additional visual interpretation box, the visual interpretation box 212, is provided. The visual interpretation box 202 includes a visual interpretation of the resultant data set of the chart type, the visual interpretation box 210 includes a visual interpretation of the resultant data set of the color coded line graph type, and the visual interpretation box 212 includes a visual interpretation of the resultant data set of the color coded map type.

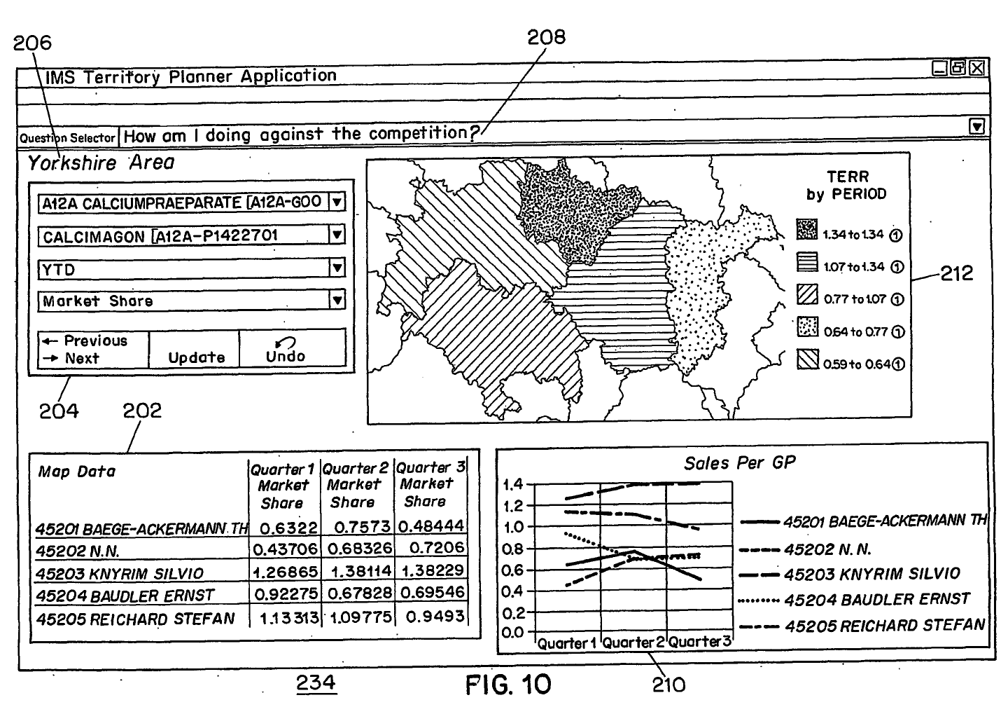

Referring now to FIG. 10, a desktop block diagram 234 of the client data presentation application is provided. The desktop block diagram 234 is largely the same as the desktop block diagram 232, except that the visual interpretation box 212 is provided having a different size. The visual interpretation box 202 includes a visual interpretation of the resultant data set of the chart type, the visual interpretation box 210 includes a visual interpretation of the resultant data set of the color coded line graph type, and the visual interpretation box 212 includes a visual interpretation of the resultant data set of the color coded map type. The visual interpretation box 212 has been resized such that the horizontal size of the visual interpretation box 212 is smaller. The size of any of the visual interpretation boxes 202, 210, 212, 214, 216 can be changed in the vertical or horizontal directions.

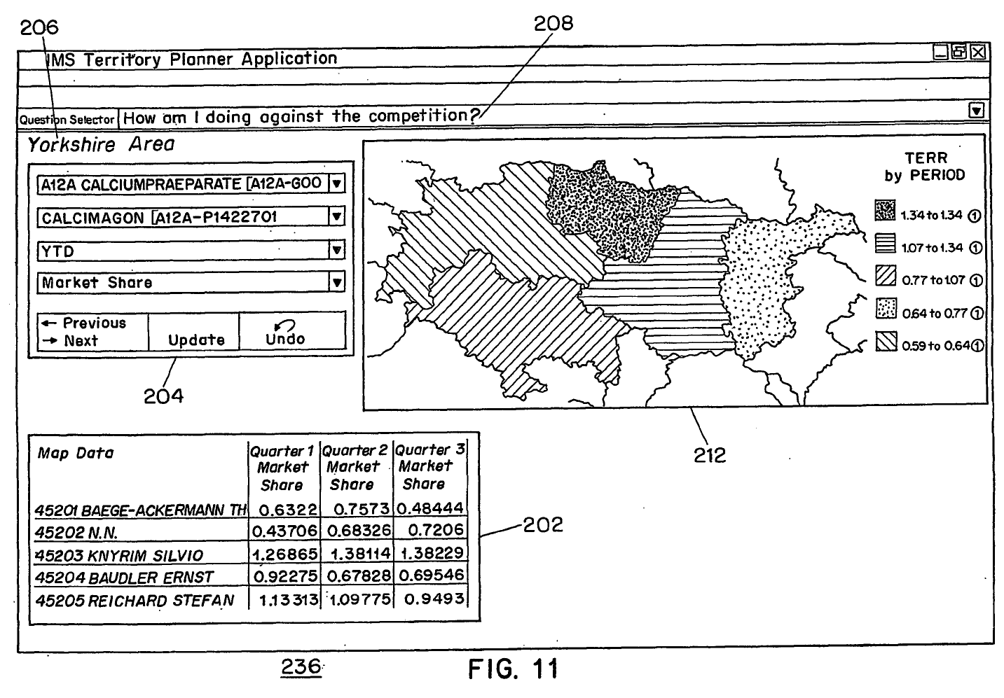

Referring now to FIG. 11, a desktop block diagram 236 of the client data presentation application is provided. The desktop block diagram 236 is largely the same as the desktop block diagram 234, except that the visual interpretation box 210 has been removed from the desktop of the client data presentation application.

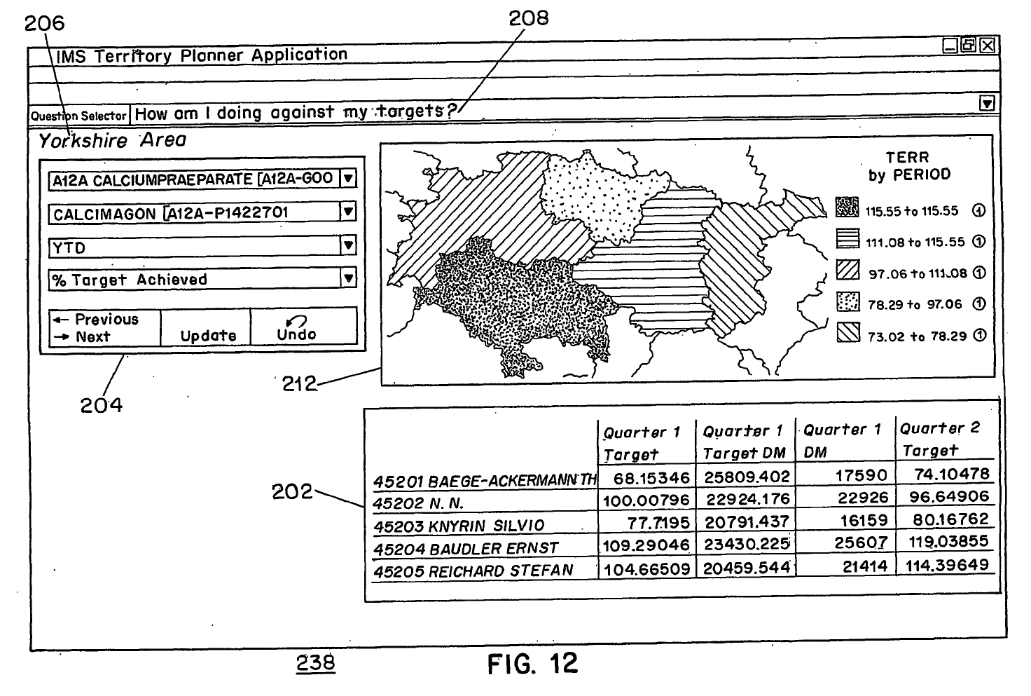

Referring now to FIG. 12, a desktop block diagram 238 of the client data presentation application is provided. The desktop block diagram 238 is largely the same as the desktop block diagram 236, except that the question specified in the question drop down menu 208 is different, one of the parameters specified in the parameter specification box 204 has been changed, the visual interpretation box 202 has been moved, and the visual interpretation boxes 204, 208 reflect a different data set. The question specified in the question drop down menu 208 has been changed from “How am I doing against by completion?” to “How am I doing against my targets?”. Related to this change, one of the parameters specified in the parameter specification box 204 has also been changed. The parameter “Market Share” has been changed to “% Target Achieved”. The visual interpretation provided in the visual interpretation boxes 202, 212 reflects these changes, such that the visual interpretation provided in the visual interpretation boxes 202, 212 is based on data collected by a query or queries associated with the newly selected question and parameters, therefore a user must have clicked on the update button.

Once the question and parameters change, a user may click on the update button. Clicking on the update button causes the client data presentation application to issue a new query or queries to the application server 102 as described in association with steps 164 through 176 of the process 150 of FIG. 2. New visual interpretations of the newly acquired resultant data are provided to the visual interpretation boxes 202, 212 shortly thereafter. The visual interpretation box 202 is also moved. Each of the visual interpretation boxes 202, 204, 206, 208, 210, 212 can be moved throughout the desktop of the client data presentation application.

The foregoing merely illustrates the principles of the invention. Various modifications and alterations to the described embodiments will be apparent to those skilled in the art in view of the teachings herein. For example, sales management data pertaining to industries other than the pharmaceutical or healthcare industries may be used. Likewise, other visual interpretations, for example, pie charts, may be used to present the data to users. It will thus be appreciated that those skilled in the art will be able to devise numerous techniques which, although not explicitly described herein, embody the principles of the invention and are thus within the spirit and scope of the invention.

1. A method of analyzing sales management data, comprising the steps of:
(a) providing a plurality of natural language questions relating to said sales management data, wherein each of the natural language questions corresponds to at least one database query,
(b) receiving an indication of a selected one or more of the natural language questions from the plurality of natural language questions;
(c) querying at least one database in accordance with the selected one or more of the natural language questions; and
(d) creating a particular data set responsive to step (c), wherein the particular data set is configured to be able to provide a particular visual interpretation thereof, wherein the particular visual interpretation is of a particular type.

2. The method of claim 1, wherein the particular visual interpretation is one of a chart, a color coded line graph, a color coded map, and a customer list.

3. The method of claim 1, wherein the particular data set is configured to be able to provide a second visual interpretation thereof, wherein the second visual interpretation is of a second type.

4. The method of claim 3, wherein the second visual interpretation is one of a chart, a color coded line graph, a color coded map, and a customer list.

5. The method of claim 1, further comprising the steps of:
querying at least one database in accordance with another one or more of the plurality of natural language questions;
receiving a second data set responsive to the querying of the at least one database in accordance with the another one or more of the plurality of natural language questions from the at least one database;
sending the second data set to the destination, the second data set configured to be able to provide a third visual interpretation thereof, wherein the third visual interpretation is of the particular type.

6. The method of claim 5, wherein the third visual interpretation replaces the particular visual interpretation.

7. The method of claim 1, further comprising the step of:
transmitting the particular data set to a destination.

8. The method of claim 7, wherein the destination is a personal computer.

9. A method of analyzing sales management data, comprising the steps of:
(a) providing a plurality of natural language questions, wherein each of the natural language questions correspond to at least one database query,
(b) selecting one or more of the natural language questions from the plurality of natural language questions;
(c) issuing an at least one query to at least one database in accordance with the selected one or more of the plurality of natural language questions;
(d) receiving a particular data set responsive to the issuing step; and
(e) analyzing the particular data set and providing a particular visual interpretation thereof, wherein the particular visual interpretation is of a particular type.

10. The method of claim 9, wherein the particular visual interpretation is one of a chart, a color coded line graph, a color coded map, and a customer list.

11. The method of claim 9, wherein the particular visual interpretation can be moved on a screen.

12. The method of claim 9, wherein the particular visual interpretation can be resized.

13. The method of claim 9, further comprising the step of: using the received data set to provide a second visual interpretation thereof, wherein the second visual interpretation is of a second type.

14. The method of claim 13, wherein the second visual interpretation is one of a chart, a color coded line graph, a color coded map, and a customer list.

15. The method of claim 13, wherein the second visual interpretation can be moved on a screen.

16. The method of claim 13, wherein the second visual interpretation can be resized.

17. The method of claim 9, further comprising the steps of:
querying at least one database in accordance with another one or more of the plurality of natural language questions;
receiving a second data set responsive to the querying of the at least one database in accordance with another of the plurality of natural language questions from the at least one database;
using the second data set to provide a third visual interpretation of the particular type.

18. The method of claim 17, wherein the third visual interpretation replaces the particular visual interpretation.

19. The method of claim 17, wherein the third visual interpretation can be moved on a screen.

20. The method of claim 17, wherein the third visual interpretation can be resized.

21. A sales management data analysis system, comprising:
a data storage unit including a mass storage device, the data storage unit including at least one database;
a processor operatively connected to the data storage unit and configured to provide a plurality of natural language questions, wherein each of the natural language questions correspond to at least one database query, to query the at least one database in accordance with a selected one of the plurality of natural language questions, to create a particular data set responsive to the querying of the at least one database in accordance with the one of the plurality of natural language questions from the at least one database; and
a communication interface, operatively connected to the processor configured to send the particular data set to a destination, the particular data set configured to be able to provide a particular visual interpretation thereof, wherein the particular visual interpretation is of a particular type.

22. The sales management data analysis system of claim 19, wherein the particular visual interpretation is one of a chart, a color coded line graph, a color coded map, and a customer list.

23. The sales management data analysis system of claim 19, wherein the particular data set is configured to be able to provide a second visual interpretation thereof, wherein the second visual interpretation is of a second type.

24. The sales management data analysis system of claim 21, wherein the second visual interpretation is one of a chart, a color coded line graph, a color coded map, and a customer list.

25. The sales management data analysis system of claim 19, wherein the processor is configured to query the at least one database in accordance with another of the plurality of natural language questions, to receive a second data set responsive to the querying of the at least one database in accordance with another of the plurality of natural language questions from the at least one database; and wherein the communication interface is configured to send the second data set to the destination, the second data set configured to be able to provide a third visual interpretation thereof, wherein the third visual interpretation is of the particular type.

26. The sales management data analysis system of claim 23, wherein the third visual interpretation replaces the particular visual interpretation.
